(19) United States
(12) Patent Application Publication
(10) Pub. No.: US 2021/0294701 A1
(43) Pub. Date: Sep. 23, 2021

(54) METHOD OF PROTECTING DATA IN HYBRID CLOUD

(71) Applicant: Hitachi, Ltd., Tokyo (JP)

(72) Inventors: Ai SATOYAMA, Tokyo (JP); Tomohiro KAWAGUCHI, Tokyo (JP)

(21) Appl. No.: 17/017,962

(22) Filed: Sep. 11, 2020

(30) Foreign Application Priority Data
Mar. 23, 2020 (JP) 2020-050977

(51) Int. Cl. G06F 11/14

(52) U.S. Cl. CPC G06F 11/1464; G06F 2201/84; G06F 11/1451

(57) ABSTRACT

There is a need to backup data consistent with data in an online volume of local storage (a storage system provided by a person different from the one who provides the cloud-based storage system) in a hybrid cloud without degrading I/O performance of the online volume. The local storage generates a backup area where data written to the online volume is backed up. The local storage associates the backup area with a server system that provides access to cloud storage from the local storage. The local storage writes the data attached to a write request to the online volume and backs up the data in the backup area. The local storage transmits the data from the backup area to the server system to write the data to the cloud storage.

### CROSS-REFERENCE TO RELATED APPLICATION

The present application claims priority from Japanese application JP 2020-050977, filed on Mar. 23, 2020, the contents of which is hereby incorporated by reference into this application.

### BACKGROUND

The present invention generally relates to a data protection technology including data backup.

Examples of data protection include backup and disaster recovery. For example, the technology disclosed in US2005/0033827 is known as a technology concerning backup and disaster recovery.

### SUMMARY

There is known a hybrid cloud including on-premise storage (on-premise-based storage system) and cloud storage (cloud-based storage system). The backup (and disaster recovery) in the hybrid cloud draws attention.

A possible method of backup in the hybrid cloud is to transfer data from an online volume (logical volume where data is written according to a write request from an application such as a application program running on the server system) in the on-premise storage to the cloud storage.

According to this method, however, the timing to store the transferred data in the cloud storage depends on a cloud storage gateway. Generally, the hybrid cloud includes the cloud storage gateway that intermediates between the on-premise storage and the cloud storage and allows the on-premise storage to access the cloud storage. The cloud storage gateway determines the timing to transfer data transferred from the on-premise storage to the cloud storage. It is difficult to maintain the consistency between data in the online volume and data in the cloud storage. Under this environment, data lost from the online volume cannot be restored. The online volume may be subject to degradation of I/O (Input/Output) throughput.

This issue may also occur on a storage system other than the on-premise storage, such as a private-cloud-based storage system provided by a party different from the party that provides the cloud storage.

A storage system provided by a person different from those who provide a cloud-based storage system is generically referred to as “local storage.” The local storage generates a backup area as a storage area to which data written in the online volume is backed up. When accepting a write request specifying the online volume, the local storage writes data attached to the write request to the online volume and backs up the data in the backup area. The local storage transmits the data backed up in the backup area to the server system to write the data to the cloud storage.

The hybrid cloud can back up data consistent with data in the online volume of the local storage without degrading I/O performance of the online volume.

### BRIEF DESCRIPTION OF THE DRAWINGS

FIG. 1 illustrates a physical configuration of the entire system according to an embodiment;

FIG. 2 illustrates a logical configuration of the entire system according to an embodiment;

FIG. 3 illustrates an example of information and programs stored in the memory of on-premise storage;

FIG. 4 illustrates an example of information and programs stored in the memory of a server system;

FIG. 5 illustrates an example of information stored in a shared area included in the on-premise storage;

FIG. 6 illustrates an example of a VOL management table;

FIG. 7 illustrates an example of a VOL pair management table;

FIG. 8 illustrates an example of a journal management table;

FIG. 9 illustrates an example of a VOL mapping table included in the on-premise storage;

FIG. 10 illustrates an example of a VOL mapping table included in the server system;

FIG. 11 is a flowchart illustrating a system configuration process;

FIG. 12 is a flowchart illustrating a clustering process (S1010 in FIG. 11);

FIG. 13 is a flowchart illustrating a backup process;

FIG. 14 is a flowchart illustrating an error recovery process;

FIG. 15 is a flowchart illustrating a snapshot acquisition process;

FIG. 16 illustrates a physical configuration of the entire system according to a modification;

FIG. 17 outlines the error recovery process according to the embodiment;

FIG. 18 provides a comparative example of the snapshot acquisition process; and

FIG. 19 outlines the snapshot acquisition process according to the embodiment.

### DETAILED DESCRIPTION

In the description below, a “communication interface apparatus” may represent one or more communication interface devices. The one or more communication interface devices may represent the same type of one or more communication interface devices such as one or more NICs (Network Interface Cards) or different types of two or more communication interface devices such as NIC and HBA (Host Bus Adapter).

In the description below, “memory” may represent one or more memory devices exemplifying one or more storage devices and may typically represent the main storage device. At least one memory device in the memory may represent a volatile memory device or a nonvolatile memory device.

In the description below, a “persistent storage apparatus” may represent one or more persistent storage devices exemplifying one or more storage devices. The persistent storage device may typically represent a nonvolatile storage device (such as an auxiliary storage device) and may specifically represent HDD (Hard Disk Drive), SSD (Solid State Drive), NVMe (Non-Volatile Memory Express) drive, or SCM (Storage Class Memory), for example.

In the description below, a “storage apparatus” may represent the memory and at least memory of the persistent storage apparatus.

In the description below, a “processor” may represent one or more processor devices. At least one processor device may typically represent a microprocessor device such as a CPU (Central Processing Unit) or other types of a processor device such as a GPU (Graphics Processing Unit). At least one processor device may represent a single-core processor or multi-core processor. At least one processor device may represent a processor core. At least one processor device may represent a circuit as a collection of gate arrays to perform all or part of processes based on a hardware description language, namely, a processor device in a broad sense such as FPGA (Field-Programmable Gate Array), CPLD (Complex Programmable Logic Device), or ASIC (Application Specific Integrated Circuit), for example.

In the description below, the expression such as “xxx table” may represent information that acquires output in reply to input. The information may represent data based on any structure (such as structured data or unstructured data) or a learning model such as a neural network that generates output in reply to input. Therefore, the “xxx table” can be expressed as “xxx information.” In the description below, the configuration of each table is represented as an example. One table may be divided into two or more tables. All or part of two or more tables may represent one table.

In the description below, a “program” may be used as the subject to explain a process. The program is executed by a processor to perform a predetermined process while appropriately using a storage apparatus and/or a communication interface apparatus, for example. The subject of a process may be a processor (or a device such as a controller including the processor). The program may be installed on an apparatus such as a computer from a program source. The program source may be a program distribution server or a computer-readable (such as non-transitory) recording medium, for example. In the description below, two or more programs may be implemented as one program or one program may be implemented as two or more programs.

In the description below, “VOL” stands for a logical volume and may represent a logical storage device. The VOL may represent a real VOL (RVOL) or a virtual VOL (VVOL). The “RVOL” may represent a VOL based on the persistent storage apparatus included in a storage system that provides the RVOL. The “VVOL” may represent any of an external connection VOL (EVOL), a thin provisioning VOL (TPVOL), and a snapshot VOL (SS-VOL). The EVOL may represent a VOL that is based on storage space (such as VOL) of an external storage system and follows a storage virtualization technology. The TPVOL may represent a VOL that includes a plurality of virtual areas (virtual storage areas) and follows a capacity virtualization technology (typically, thin provisioning). The SS-VOL may represent a VOL provided as a snapshot of an original VOL. The SS-VOL may represent an RVOL.

In the description below, common symbols of reference symbols may be used to explain the same type of elements with no distinction. Reference symbols may be used to explain the same type of elements apart.

The description below explains an embodiment. The embodiment uses public storage (public-cloud-based storage system) as an example of cloud storage (cloud-based storage system). On-premise storage (on-premise-based storage system) is used as an example of local storage (storage system provided by a party different from a party providing the cloud-based storage system). However, the cloud storage and the local storage may not be limited to the above-described examples. For example, the local storage may represent private storage (private-cloud-based storage system).

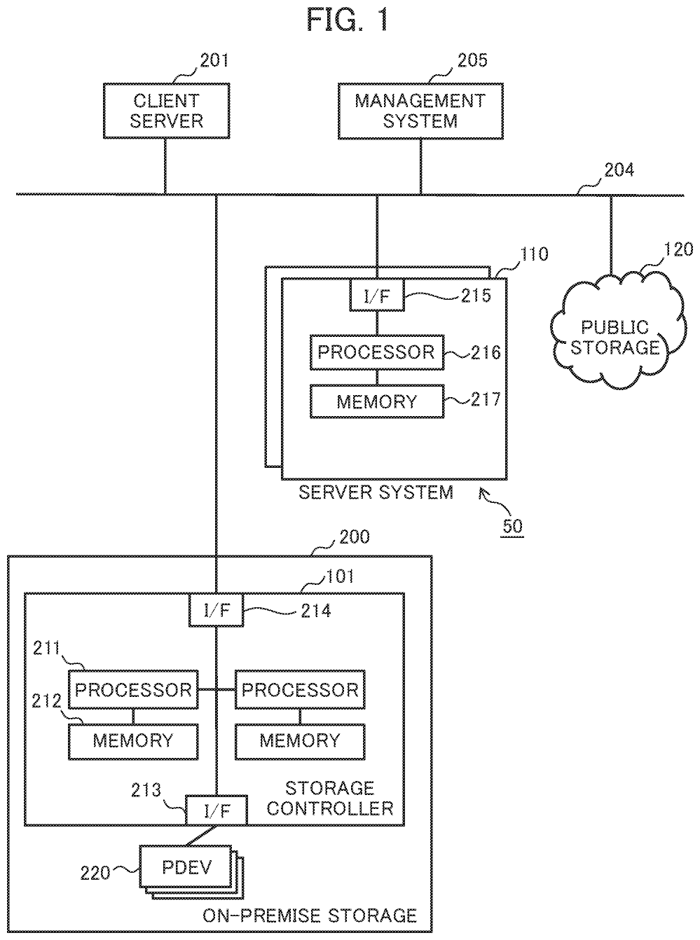

FIG. 1 illustrates a physical configuration of the entire system according to the embodiment.

A network (typically, IP (Internet Protocol) network) 204 connects with an on-premise storage 200, a server system 50, a public storage 120, a client server 201, and a management system 205.

The on-premise storage 200 provides a business VOL (specified by I/O request from an application performed on the client server 201). The client server 201 transmits a write or read request assigned with the business VOL to the on-premise storage 200. In reply to the write or read request, the on-premise storage 200 read or write data to the business VOL.

The on-premise storage 200 includes a PDEV group 220 and a storage controller 101 connected to the PDEV group 220.

The PDEV group 220 represents one or more PDEVs (physical storage devices). The PDEV group 220 exemplifies the persistent storage apparatus. The PDEV exemplifies the persistent storage device. The PDEV group 220 may represent one or more RAID (Redundant Array of Independent (or Inexpensive) Disks) groups.

The storage controller 101 includes a front-end I/F 214, a back-end I/F 213, memory 212, and a processor 211 connected to these. The I/F 214 and the I/F 213 exemplify a communication interface apparatus. For example, the memory 212 and the processor 211 are duplicated.

The I/F 214 is connected to the network 204. The I/F 214 allows the network 204 to communicate with the client server 201, the server system 50, the management system 205, and the storage controller 101. The I/F 214 intermediates data transfer between the storage controller 101 and the server system 50.

The I/F 213 is connected to the PDEV group 220. The I/F 213 allows data read or write to the PDEV group 220.

The memory 212 stores information or one or more programs. The processor 211 executes one or more programs to perform processes such as providing a logical volume, processing I/O (Input/Output) requests such as write or read requests, backing up data, and transferring the backup data to the server system 50 to store the data in the public storage 120.

The configuration of the on-premise storage 200 is not limited to the example illustrated in FIG. 1. For example, the on-premise storage 200 may represent a node group according to the multi-node configuration (such as distributed system) provided with a plurality of storage nodes each including a storage apparatus. Each storage node may represent a general-purpose physical computer. Each physical computer may execute predetermined software to configure SDx (Software-Defined anything). SDx can use SDS (Software Defined Storage) or SDDC (Software-defined Datacenter), for example.

As above, the on-premise storage 200 accepts write or read requests from the external system such as the client server 201. Instead, the on-premise storage 200 may represent a storage system based on the hyper-converged infrastructure such as a system including the function (such as an execution body (such as a virtual machine or a container) of an application to issue I/O requests) as a host system to issue I/O requests, and the function (such as an execution body (such as a virtual machine or a container) of storage software) as a storage system to process the I/O requests.

The public storage 120 is available as AWS (Amazon Web Services) (registered trademark), Azure (registered trademark), or Google Cloud Platform (registered trademark), for example.

The server system 50 is an appliance that intermediates data transfer between the on-premise storage 200 and the public storage 120. The server system 50 executes a data transfer program. The data transfer program exemplifies a program (such as an application program) that controls data transfer between the on-premise storage 200 and the public storage 120. The data transfer program provides the VOL and transfers data from the on-premise storage 200 to the public storage 120.

The server system 50 represents a cluster system including physical computers 110A and 110B (exemplifying a plurality of physical computers). The physical computers 110A and 110B each include an I/F 215, memory 217, and a processor 216 connected to these. The I/F 215 is connected to the network 204. The I/F 215 mediates data transfer between the on-premise storage 200 and the public storage 120. The memory 217 stores information and programs (such as a data transfer program). The processor 216 executes the program.

The management system 205 represents a computer system (one or more computers) that manages the configuration of the storage area of the on-premise storage 200.

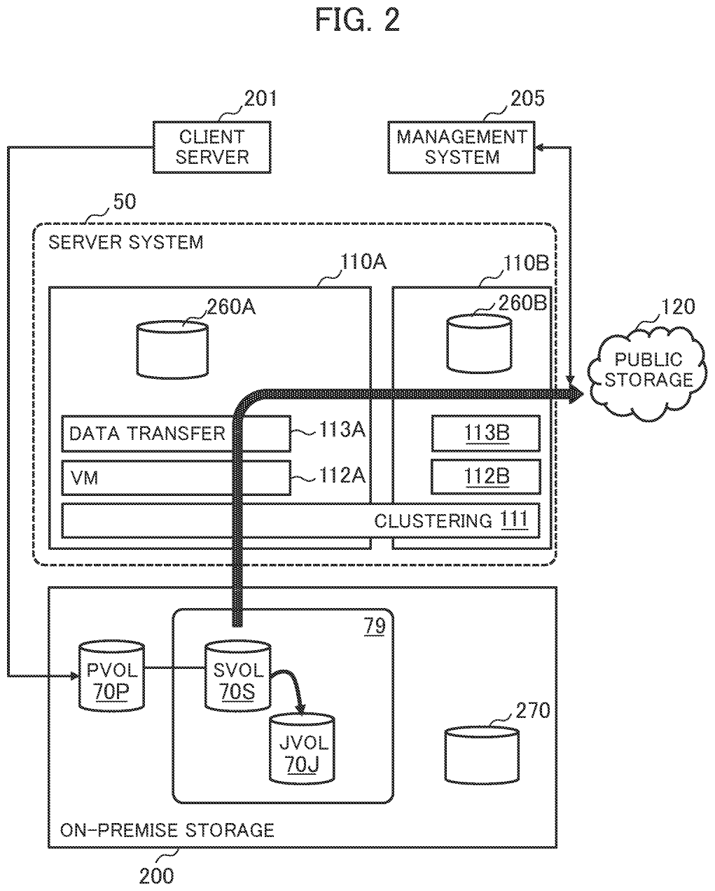

FIG. 2 illustrates a logical configuration of the entire system according to the present embodiment.

The server system 50 represents a cluster system in which a clustering program 111 clusters the physical computers 110A and 110B. The physical computers 110A and 110B each execute the clustering program 111. The clustering program 111 may conceptually include a VM management program (such as a program to create or delete a VM (virtual machine)) such as a hypervisor.

Of the physical computers 110A and 110B, the physical computer 110A is used as a representative example. The physical computer 110A generates a VM 112A. The VM 112A executes a data transfer program 113A (such as a cloud storage gateway). The data transfer program 113A generates a VOL 260A on the VM 112A and provides the generated VOL 260A to the on-premise storage 200. The physical computer 110B also performs a similar process. Namely, the physical computer 110B generates a VM 112B. The VM 112B executes a data transfer program 113B. The data transfer program 113B generates a VOL 260B on the VM 112B and provides the generated VOL 260B to the on-premise storage 200.

The processor 211 of the on-premise storage 200 assumes a business VOL supplied to the client server 201 to be a PVOL 70P. The processor 211 generates an SVOL 70S for the PVOL 70P as a data backup destination in the PVOL 70P. The SVOL 70S and the PVOL 70P configure a VOL pair. The SVOL 70S may configure at least part of the backup area as the storage area to which the data written to the business VOL is backed up. The backup process targeted at the public storage 120 uses a backup area 79 (such as the SVOL 70S) but does not use the PVOL 70P. It is possible to prevent the backup process targeted at the public storage 120 from degrading the I/O performance of the business VOL (PVOL 70P).

The processor 211 of the on-premise storage 200 generates a JVOL 70J. The JVOL 70J may configure at least part of the backup area 79. According to the present embodiment, the backup area 79 includes both the SVOL 70S and the JVOL 70J. However, one of the SVOL 70S and the JVOL 70J may be included.

The description below explains writing to the PVOL 70P, the SVOL 70S, and the JVOL 70J according to the present embodiment, for example.

The SVOL 70S is a full copy of the PVOL 70P. Therefore, the processor 211 manages a difference between the PVOL 70P and the SVOL 70S in block units, for example (in such a manner as managing a bitmap composed of a plurality of bits respectively corresponding to a plurality of blocks of the PVOL 70P). When data is written to any block in the PVOL 70P, the block is managed to be differential. The differential block causes a differential copy (data copy) from a block in the PVOL 70P to a block in the SVOL 70S. When the VOL pair of the PVOL 70P and the SVOL 70S enables a “PAIR” state, a difference occurring in the PVOL 70P is copied to the SVOL 70S, namely, the PVOL 70P and the SVOL 70S are synchronized.

When writing (copying) data to the SVOL 70S, the processor 211 stores a journal including the data in the JVOL 70J. The journal contains the data written to the SVOL 70S (consequently the data written to PVOL 70P). The journal is associated with the management information of the data. For each journal, the management information includes information indicating a storage destination address of the data in the journal and information indicating a journal number that signifies the order of the data. The journal that contains the data written to the SVOL 70S and is stored in the JVOL 70J is transmitted to the server system 50. According to the present embodiment, the journal is transmitted from the backup area 79 to the server system 50. However, instead of the journal, data in the journal may be transmitted. Data in the journal is copied to the SVOL 70S. The data exemplifies data written to the PVOL 70P.

The data copy from the PVOL 70P to the SVOL 70S is not limited to the above example. For example, the processor 211 may generate a journal including the data written to the PVOL 70P, and store the generated journal in JVOL (not shown). The processor 211 reflects journals not reflected in the SVOL 70S of the JVOL 70J in ascending order of journal numbers. Reflecting a journal in the SVOL 70S signifies writing data in the journal to the SVOL 70S. According to the present embodiment, a smaller journal number corresponds to an older journal (past journal). Therefore, the “ascending order of journal numbers” exemplifies the chronological order of journals. In this example, a journal (or data in the journal) transmitted to the server system 50 may represent a journal (or data in the journal) reflected from the JVOL to the SVOL.

The on-premise storage 200 includes a shared area 270. An example of the shared area 270 may be a VOL (such as a VOL based on the PDEV group 220). The shared area 270 is a storage area shared by the on-premise storage 200 (particularly the processor 211) and the physical computers 110A and 110B. The VOL 260A is mapped to the SVOL 70S. The shared area 270 stores information indicating an IP address (an example of the address) of the VOL 260A. Therefore, the processor 211 transfers the journal containing data written in the PVOL 70P and backed up in the SVOL 70S to the VOL 260A whose IP address is mapped to the SVOL 70S. For example, the IP address is used to transmit a request to write the journal. The data transfer program 113A stores the transferred journal in the VOL 260A. Storing the journal in the VOL 260A may be comparable to accumulating the journal in the memory 217 of the physical computer 110A, for example. Suppose the physical computer 110A includes a persistent storage apparatus and the VOL 260A is based on the persistent storage apparatus. Then, the data may be stored in the persistent storage apparatus. The data transfer program 113A transfers data in the journal to the public storage 120 in ascending order of the journal numbers based on the management information associated with the journal stored in the VOL 260A.

According to the present embodiment, the physical computer 110A is active (active system) and the physical computer 110B is standby (standby system). A fail-over is performed when an error is detected in the physical computer 110A. Specifically, as described later, the physical computer 110B of the server system 50 identifies the IP address from the shared area 270 of the on-premise storage 200, for example. The identified IP address is inherited from the physical computer 110A (VOL 260A) to the physical computer 110B (VOL 260B). After the fail-over, the processor 211 uses the IP address to transfer the journal (data) to the VOL 260B.

The management system 205 may monitor the transfer status of data from the server system 50 to the public storage 120 (and/or the transfer status of data from the SVOL 70S to the server system 50).

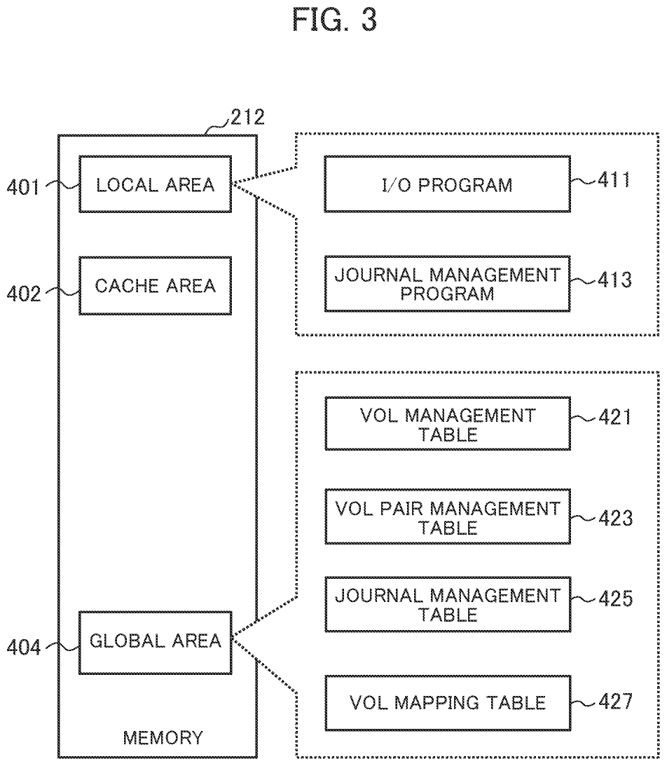

FIG. 3 illustrates an example of information and programs stored in the memory 212 of on-premise storage 200.

The memory 212 includes a local area 401, a cache area 402, and a global area 404. At least one of these memory areas may provide independent memory.

The processor 211 belonging to the same set as the memory 212 uses the local area 401. The local area 401 stores an I/O program 411 and a journal management program 413, for example, as programs executed by the processor 211.

The cache area 402 temporarily stores data to be written or read from the PDEV group 220.

The global area 404 is used by both the processor 211 belonging to the same set as the memory 212 including the global area 404 and the processor 211 belonging to a set different from the set. The global area 404 stores storage management information. The storage management information includes a VOL management table 421, a VOL pair management table 423, a journal management table 425, and a VOL mapping table 427, for example.

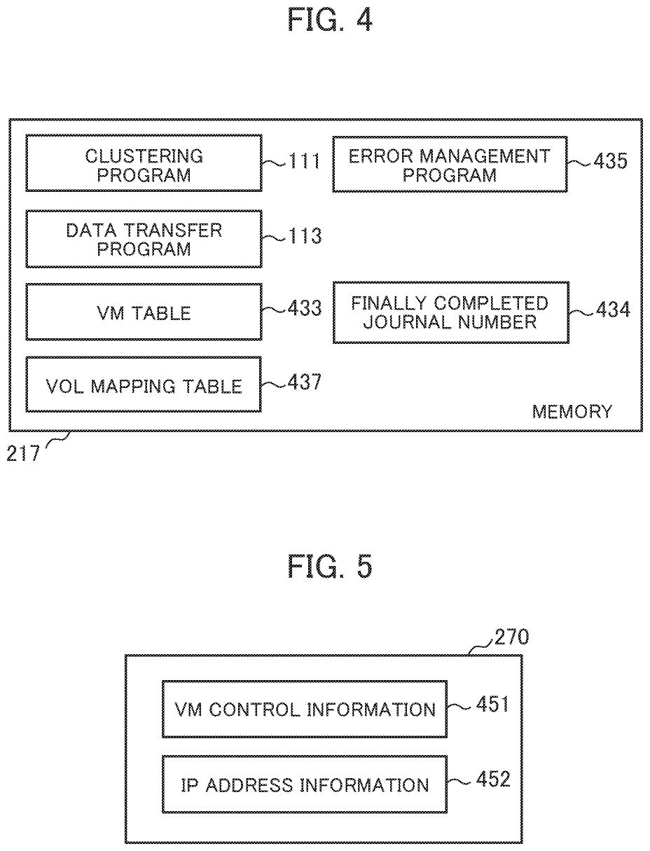

FIG. 4 illustrates an example of information and programs stored in the memory 217 of a server system 50.

The memory 217 stores the clustering program 111, the data transfer program 113, a VM table 433, a finally completed journal number 434, and an error management program 435.

The clustering program 111 assumes the physical computers 110A and 110B to be the single server system 50.

The data transfer program 113 transfers data between the on-premise storage 200 and the public storage 120.

The VM table 433 maintains information about the VM on a VM basis. For example, the information about the VM includes an OS (such as guest OS) executed by the VM, an application program, a VM ID, and information indicating the state of the VM.

The finally completed journal number 434 represents the number assigned to a journal containing the data last transferred to the public storage 120. The data transfer program 113 stores journals from the on-premise storage 200 in the VOL 260. Suppose a journal is stored in the VOL 260, contains data not transferred to the public storage 120, and is assigned the smallest journal number. Then, the data transfer program 113 transfers data in this journal to the public storage 120. When a completion response returns from the public storage 120, the data transfer program 113 may delete the journal from the VOL 260. The data transfer program 113 overwrites the finally completed journal number 434 with the journal number of that journal. The journal number of a journal signifies the order in which the journal is stored in the PVOL 70P, namely, the order of update.

The error management program 435 monitors whether an error occurs on the physical computer 110 in the server system 50. When an error is detected, the error management program 435 performs fail-over between the physical computers 110.

FIG. 5 illustrates an example of information stored in the shared area 270 included in the on-premise storage 200.

The shared area 270 VM control information 451 and IP address information 452, for example. The VM control information 451 includes information for controlling the VM 112, for example, information indicating the number of resources (such as VOLs) allocated to each VM 112. The IP address information 452 represents an IP address assigned to the VOL 260.

The description below explains configuration examples of the tables.

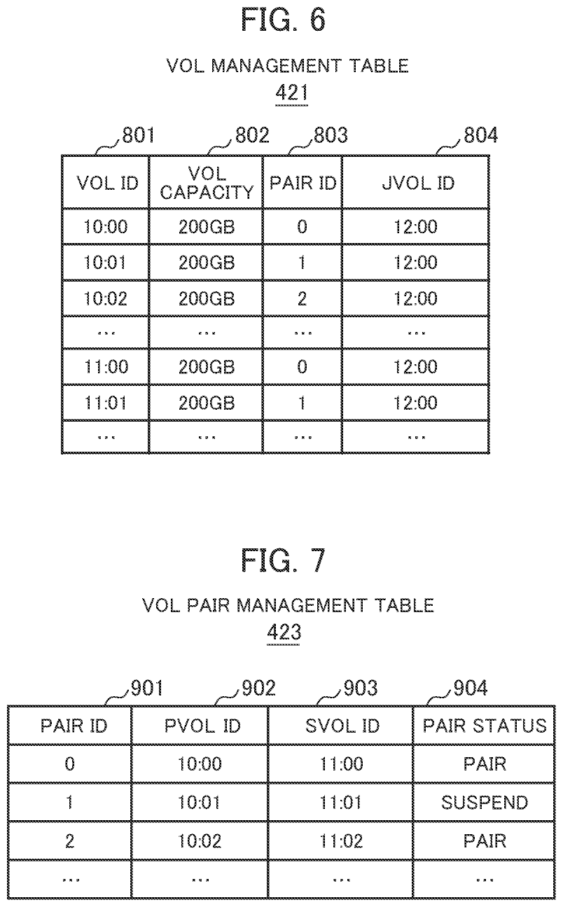

FIG. 6 illustrates an example of the VOL management table 421.

The VOL management table 421 maintains information about VOLs that the on-premise storage 200 includes. The VOL management table 421 includes an entry for each VOL included in the on-premise storage 200. Each entry stores information such as VOL ID 801, VOL capacity 802, pair ID 803, and JVOL ID 804. The description below uses one VOL (“target VOL” in the description of FIG. 6) as an example.

The VOL ID 801 represents a number (identification number) of the target VOL. The VOL capacity 802 represents the capacity of the target VOL. The pair ID 803 represents the pair ID of a VOL pair including the target VOL. The JVOL ID 804 represents a JVOL number (identification number) associated with the VOL pair including the target VOL. The JVOL may be provided for each VOL pair or may be provided in common with two or more VOL pairs.

Each entry of the VOL management table 421 may maintain at least one of VOL attributes (unshown) or other information. The VOL attributes include an attribute indicating whether the target VOL is PVOL, SVOL, or JVOL; PDEV ID representing each ID of one or more PDEVs based on VOL; a RAID level of the RAID group as a basis of the target VOL; LUN (Logical Unit Number) as an ID of the target VOL specified from the client server 201; and a physical port number as an identification number of the physical port used for I/O to and from the target VOL.

When data is written to the PVOL 70P, the JVOL 70J as a destination of writing the data is identified from the JVOL ID 804 corresponding to the pair ID 803 of the VOL pair including the PVOL 70P.

FIG. 7 illustrates an example of the VOL pair management table 423.

The VOL pair management table 423 maintains information about a VOL pair (a pair of PVOL and SVOL). The VOL pair management table 423 includes an entry for each VOL pair. Each entry stores information such as pair ID 901, PVOL ID 902, SVOL ID 903, and pair status 904. The description below uses one VOL pair (“target VOL pair” in the description of FIG. 7) as an example.

The pair ID 901 represents a number (identification number) of the target VOL pair. The PVOL ID 902 represents a PVOL number in the target VOL pair. The SVOL ID 903 represents an SVOL number in the target VOL pair. The pair status 904 represents a replication state in the target VOL pair. For example, the pair status 904 provides values such as “COPY” (copying data from PVOL to SVOL), “PAIR” (the synchronous state between PVOL and SVOL), and “SUSPEND” (the asynchronous state between PVOL and SVOL).

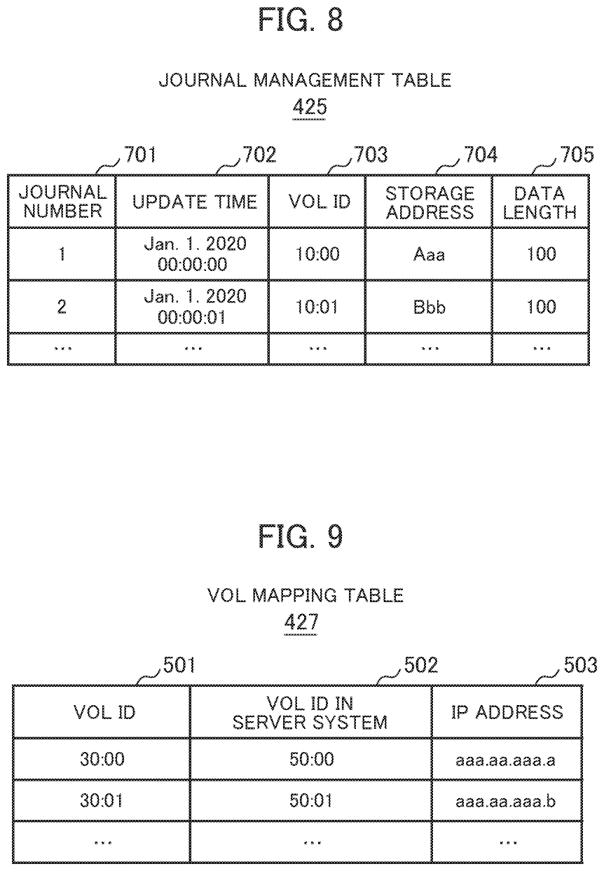

FIG. 8 illustrates an example of the journal management table 425.

The journal management table 425 maintains the management information of each journal. The journal management table 425 includes an entry for each journal. Each entry stores information included in the management information, for example, a journal number 701, update time 702, a VOL ID 703, a storage address 704, and a data length 705. The description below uses one journal (“target journal” in the description of FIG. 8) as an example.

The journal number 701 represents a number of the target journal. The update time 702 represents the time (update time) when the data in the target journal was written to the SVOL. The VOL ID 703 represents an ID of the SVOL 70S that stores the data in the target journal. The storage address 704 represents the start address of an area (an area in the SVOL 70S) that stores data in the target journal. The data length 705 indicates the length of data in the target journal. In terms of the target journal, the storage address 704 and the data length 705 represent the entire area that stores data in the target journal.

The journal management table 425 is stored in the memory 212 of the on-premise storage 200. The journal management table may also be stored in the memory 217 of the server system 50. For example, the data transfer program 113 may store a journal transferred from on-premise storage 200 in VOL 260. Data in journals in VOL 260 may be transferred to the public storage 120 in ascending order of journal numbers. For example, a data write request may be transmitted to the public storage 120. In this case, the public storage 120 may be assigned information included in the management information of the journal, for example, information indicating the storage address and the data length. In the journal management table of the server system 50, the storage address included in the management information represents the address of an area containing data in the journal stored in VOL 260. For example, the storage address may represent the address of the memory 217 in the server system 50.

FIG. 9 illustrates an example of the VOL mapping table 427 included in the on-premise storage 200.

The VOL mapping table 427 maintains information on the VOL 260 mapped to the SVOL 70S based on each SVOL 70S included in the on-premise storage 200. The VOL mapping table 427 includes an entry for each SVOL 70S. Each entry stores information such as VOL ID 501, VOL ID 502 in the server system, and IP address 503. The description below uses one SVOL 70S (“target SVOL 70S” in the description of FIG. 9) as an example.

The VOL ID 501 represents a number of the target SVOL 70S. The VOL ID 502 in the server system represents a number of the VOL 260 mapped to the target SVOL 70S in the server system 50. The IP address 503 represents an IP address of the VOL 260 mapped to the target SVOL 70S.

The mapping allows the journal to transfer from the SVOL 70S to the VOL 260 mapped to the SVOL 70S.

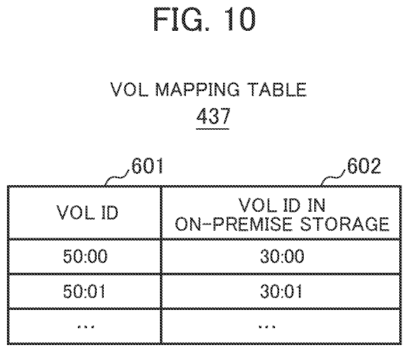

FIG. 10 illustrates an example of the VOL mapping table 437 included in the server system 50.

The VOL mapping table 437 maintains information on the SVOL 70S mapped to the VOL 260 based on each VOL 260 included in the server system 50. The VOL mapping table 437 includes an entry for each VOL 260. Each entry stores information such as VOL ID 601 and VOL ID 602 in the on-premise storage. The description below uses one VOL 260 (“target VOL 260” in the description of FIG. 10) as an example.

The VOL ID 601 represents a number of the target VOL 260. The VOL ID 602 in the on-premise storage represents a number of the SVOL 70S mapped to the target VOL 260 in the on-premise storage 200.

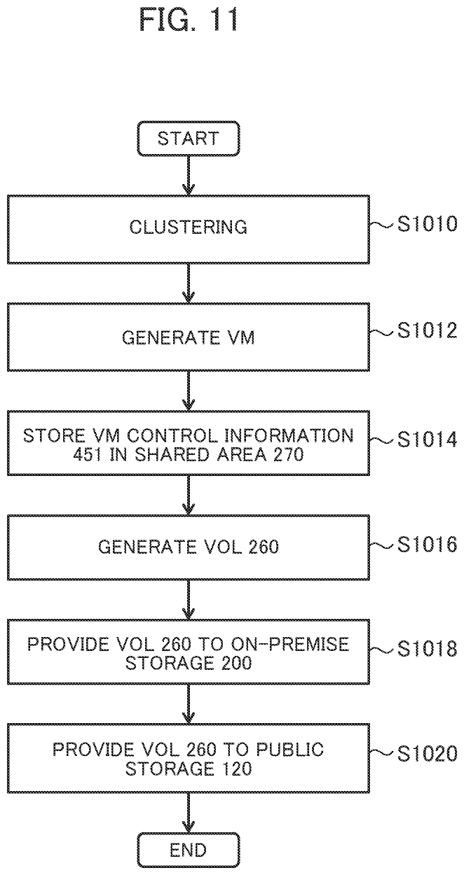

FIG. 11 is a flowchart illustrating a system configuration process.

An administrator of the on-premise storage 200 prepares the physical computers 110A and 110B. For example, each of the physical computers 110A and 110B may be available as an existing physical computer owned by a customer who uses the on-premise storage 200. The physical computers 110A and 110B are used as the server system 50. The server system 50 is connected to the on-premise storage 200, the client server 201, and the public storage 120 via the network 204. The clustering program 111 is installed on each physical computer 110. The clustering program 111 allows the physical computers 110A and 110B to configure a cluster system (S1010).

Each physical computer 110 generates the VM 112 (S1012). The physical computers 110A and 110B constitute the same VM environment.

The VM control information 451 of the VM 112 is stored in the shared area 270 in the on-premise storage 200 (S1014). The physical computers 110A and 110B share the VM control information 451.

In each physical computer 110, the data transfer program 113 executed by the VM 112 generates the VOL 260 on the VM 112 (S1016).

A path is formed between the on-premise storage 200 and the server system 50. The data transfer program 113A of the active physical computer 110A issues an inquiry command to the on-premise storage 200 and thereby detects the SVOL 70S of the on-premise storage 200, for example. The data transfer program 113A maps the VOL 260 to the detected SVOL 70S and provides the VOL 260 to the on-premise storage 200 (S1018). The VOL mapping table 437 records the mapping relationship between the SVOL 70S and the VOL 260.

The data transfer program 113A provides the generated VOL 260 to the public storage 120 such as VOL (unshown) in the public storage 120 (S1020). The data transfer program 113 backs up data from the VOL 260 to the VOL in the public storage 120. The backup process will be described later.

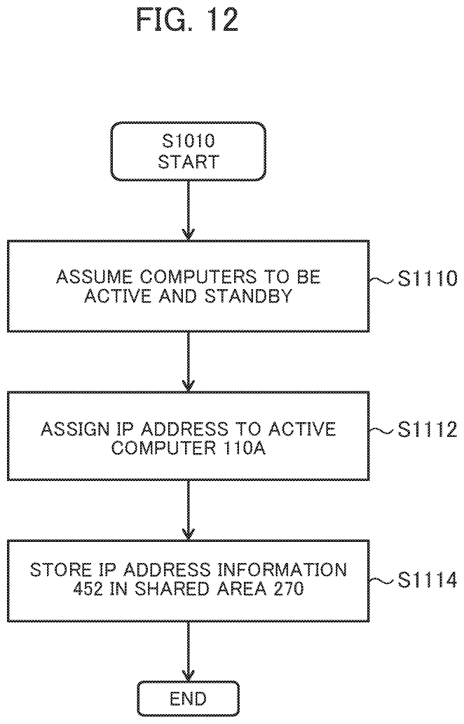

FIG. 12 is a flowchart illustrating a clustering process (S1010 in FIG. 11).

The management system 205 selects one physical computer 110 from the server system 50. According to the example illustrated in FIG. 2, the selected physical computer 110 is assumed to be the physical computer 110A. The management system 205 assumes the state of this physical computer 110A to be “active.” The management system 205 assumes the state of another physical computer 110B to be “standby” (S1110).

The clustering program 111 of the active physical computer 110A generates a cluster configuration along with the standby physical computer 110B. A path is formed between the active physical computer 110A and the on-premise storage 200. The management system 205 manages operations of the physical computer 110A and the standby state of the physical computer 110B and assigns an IP address to the active physical computer 110A (S1112). The management system 205 stores the IP address information 452 representing the IP address in the shared area 270 (S1114). The IP address is associated with the VOL 260 generated at S1016 and is registered as the IP address 503 to the VOL mapping table 427.

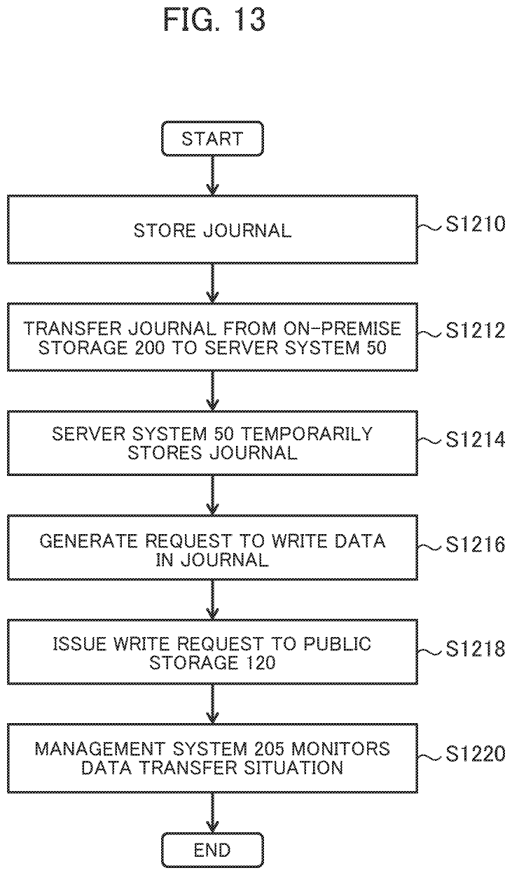

FIG. 13 is a flowchart illustrating a backup process.

The VOL 70P is fully copied to the VOL 70S. Then, the VOL 70S is thereby assumed to be equal to the VOL 70P. Data of the VOL 70S is backed up to the public storage 120 via the VOL 260 of the server system 50. Specifically, for example, data of the SVOL 70S may be transferred to the public storage 120 via the VOL 260 immediately after the full copy (initial copy) from the PVOL 70P to the SVOL 70S. This can allow the PVOL 70P, the SVOL 70S, and the public storage 120 to maintain the same data. When data is subsequently written to the PVOL 70, the I/O program 411 copies the data to SVOL 70S. The I/O program 411 stores the journal containing the data in the JVOL 70J. The journal management program 413 registers the management information of the data in the journal to the journal management table 425. The I/O program 411 may transfer the journal to the VOL 260. Data in the journal may be transferred from the VOL 260 to the public storage 120. Specifically, FIG. 13 illustrates the backup process when data is written to the PVOL 70P after the full copy from the PVOL 70P to the SVOL 70S and the data is copied to the SVOL 70S (when the SVOL 70S is updated).

When data is written to the SVOL 70S, the I/O program 411 generates a journal containing the data and stores the journal in the JVOL 70J. The journal management program 413 registers the management information of the journal to the journal management table 425 (S1210).

The I/O program 411 identifies the IP address 503 of the VOL 260A mapped to the SVOL 70S from the VOL mapping table 427 and uses the IP address 503 to transfer the journal generated at S1210 to the VOL 260A (S1212). For example, either of the following may be performed to transfer a journal from the on-premise storage 200 to the server system 50. One of the following may be retried if the server system 50 cannot receive a journal.
When the VOL 260A ensures the free space larger than or equal to the required amount, the data transfer program 113 of the server system 50 transmits a journal transfer request from the server system 50 to the on-premise storage 200 and receives the journal in response to the request.
The I/O program 411 of the on-premise storage 200 transmits a journal to the server system 50. When the VOL 260A of the server system 50 ensures the free space larger than or equal to the required amount, the data transfer program 113 of the server system 50 receives the journal and writes it to the VOL 260A.

When receiving the journal transferred from the on-premise storage 200, the data transfer program 113A of the server system 50 stores the journal in the VOL 260A (S1214). For example, the journals are managed in the order of reception in the server system 50, namely, in the chronological order of journals (ascending order of journal numbers) updated in the on-premise storage 200.

The data transfer program 113A transfers data in the journal to the VOL in the public storage 120 corresponding to the VOL 260A in ascending order of journal numbers. For example, the data transfer program 113A selects one journal in ascending order of journal numbers. The data transfer program 113A generates a write request to write data in the selected journal to the VOL (VOL in the public storage 120) corresponding to the VOL 260A (S1216). The data to be written in reply to the write request may be specified from the storage address 704 and the data length 705 included in the management information in the selected journal. The write request may specify the storage address 704 and the data length 705. The data transfer program 113A issues the write request to the public storage 120 (S1218). As a result, the data is written in the VOL in the public storage 120. The request is not limited to the write request. It is just necessary to transfer and write data to the public storage 120.

The management system 205 monitors situations of transferring the journals stored in the VOL 260A of the server system 50 to the public storage 120 (S1220). The management system 205 overwrites the finally completed journal number 434 with the journal number of the journal containing the data last transferred to public storage 120.

Regarding the backup process, at least one of the following may be adopted instead of or in addition to at least part of the description with reference to FIG. 13.
The server system 50 includes the JVOL. The JVOL stores the journal from on-premise storage 200. Namely, the VOL 260 may be comparable to the JVOL.
The data transfer program 113A overwrites the finally completed journal number 434 with the journal number of the journal containing the data last transferred to the public storage 120.
The data transfer program 113A notifies the on-premise storage 200 of information indicating situations of transferring data in the journal from the server system 50 to the public storage 120. Namely, the journal management table 425 of the on-premise storage 200 monitors a data transfer situation (journal reflection situation) from the server system 50 to the public storage 120.
The PVOL 70P and the SVOL 70S are synchronized, and the I/O program 411 stores data written (backed up) in the SVOL 70S as a journal in the JVOL 70J. The I/O program 411 transfers a journal to the VOL 260A of the server system 50 each time the journal is stored in the JVOL 70J.

Data is transferred from the on-premise storage 200 to the VOL in the public storage 120 via the VOL 260. When the backup process is performed, it is favorable to store the backup of data written to the PVOL 70P in the public storage 120 without degrading the response performance of the PVOL 70P. The SVOL 70S is generated as a full copy of the PVOL 70P, and the VOL 260 of the server system 50 is mapped to the SVOL 70S. The on-premise storage 200 transfers the journal to the VOL 260 while the journal contains the data copied to the SVOL 70S. Thereby, the data in the journal can be backed up to the public storage 120 via the VOL 260. The backup process can be performed by backing up data copied to the SVOL 70S as a replica of the PVOL the 70P without degrading the performance of operations including the update of the PVOL 70P.

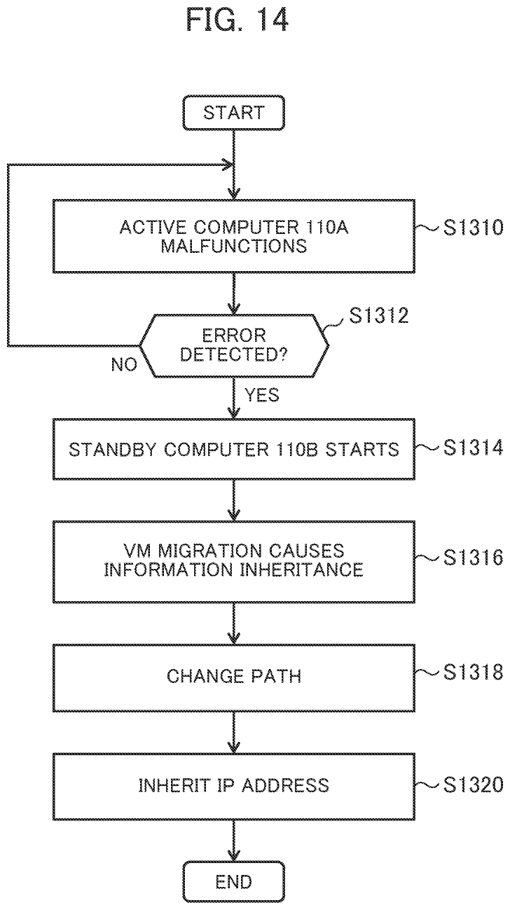

FIG. 14 is a flowchart illustrating an error recovery process.

It is determined whether an error is detected in the operating physical computer 110A (S1310). For example, an activity/inactivity confirmation process is periodically performed on the operating physical computer 110A. For example, a quorum is placed in the on-premise storage 200. The error management program 435 of each of the physical computers 110A and 110B writes states of communication with the physical computer 110 to be monitored in the quorum. For example, the error management program 435A sets a predetermined bit of the quorum to 1 periodically or in synchronization with the I/O response. The error management program 435B periodically at a predetermined time interval determines whether the predetermined bit in the quorum is set to “1.” Based on the predetermined bit, it is possible to determine the physical computer 110 to be continuously operated and the physical computer 110 to be inactivated. When the predetermined bit of the quorum is confirmed to retain the value set to “1,” it is possible to confirm that the physical computer 110A is operating normally. After the confirmation, the error management program 435B resets the value of the predetermined bit of the quorum to “0.” The predetermined bit is periodically set to “1” if the physical computer 110A is operating normally.

However, the quorum may be confirmed to retain the value set to “0.” In this case, an error occurs on the physical computer 110A. It can be seen that the value of the predetermined bit is not updated to “1.” The error management program 435B detects an error occurrence on the physical computer 110A. The above-mentioned process using the quorum is an example of the activity/inactivity confirmation process. The activity/inactivity confirmation process is not limited to the example. For example, the physical computers 110 may directly confirm the activity/inactivity by using heartbeats.

When an error is detected on the physical computer 110A (S1312: YES), the standby physical computer 110B is activated (S1314).

The VM migration migrates VM control information (such as information indicating the state of the VM) including information needed during operation of the physical computer 110A to the physical computer 110B (S1316). When the VM migration starts, a response to reject the acceptance is returned or no response is returned to time out the on-premise storage 200 so that the server system 50 does not accept the journal transfer from on-premise storage 200. The VM migration may migrate one or more journals (one or more journals not reflected in the public storage 120) accumulated in the VOL 260A from the VOL 260A to the VOL 260B. Alternatively, the management system 205 may manage the finally completed journal number 434 in the physical computer 110A. After the VM migration, the management system 205 requests the on-premise storage 200 to transmit a journal assigned a journal number larger than the finally completed journal number 434. In response to the request, the I/O program 411 of the on-premise storage 200 may transmit a journal assigned a journal number larger than the finally completed journal number 434 to the server system 50. As a result, the journal may be accumulated in the VOL 260B after the migration.

The path from the on-premise storage 200 to the active physical computer 110A is disconnected. A path to the activated standby physical computer 110B is connected (S1318). The information about the active and standby physical computers 110 is updated.

The clustering program 111 operates by assuming the physical computer 110B to be active. This allows the physical computer 110B to inherit the processing of the physical computer 110A. The VM control information is used when the processor 216 is operating in the physical computer 110A. Migration of these pieces of information to the standby physical computer 110B enables the physical computer 110B to continuously perform processor processing on the physical computer 110.

The management system 205 further allocates the IP address assigned to the VOL 260A in the physical computer 110A, namely, the IP address represented by the IP address information 452 in the shared area 270, to the VOL 260B of the physical computer 110B. In other words, the IP address is inherited (S1320). Meanwhile, the physical computer 110A may return a response representing the timeout while accepting an access request. Suppose the VM migration completes the migration and the request returned in reply to the timeout is retried. Then, the physical computer 110B accepts the request and continues the process. For example, suppose the on-premise storage 200 issues an access request to the server system 50 according to the IP address of the VOL 260 mapped to the SVOL 70S and repeatedly issues the access request based on the unsuccessful reception or timeout. Eventually, it becomes possible to access the physical computer 110B (VOL 260B) indicated by the IP address as the destination after the changeover.

The IP address inheritance may be performed during the VM migration. For example, the clustering program 111 of the physical computer 110B may specify the IP address represented by the IP address information 452 in the shared area 270 and allocate the specified IP address to the activated physical computer 110B (VOL 260B). The IP address may be included in the VM control information inherited from the physical computer 110A to the physical computer 110B.

Consequently, a redundant configuration is given to the physical computer 110 of the server system 50 that controls the data transfer between the on-premise storage 200 and the public storage 120. The shared area 270 in the on-premise storage 200 stores the information shared by the redundant physical computer 110, namely, the information including the IP address. As a result, the physical computers 110A and 110B can share information. Even if the physical computer 110A malfunctions, the fail-over is automatically performed, making it possible to continue the backup process from the on-premise storage 200 to the public storage 120.

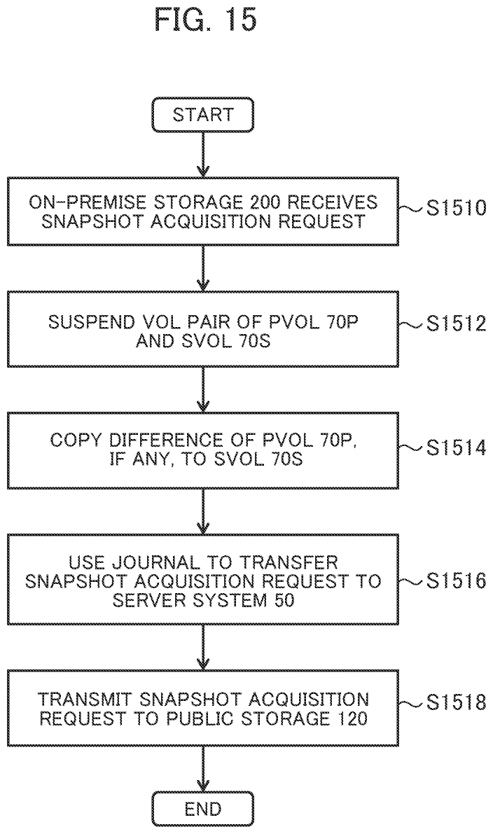

FIG. 15 is a flowchart illustrating a snapshot acquisition process.

The on-premise storage 200 receives a snapshot acquisition request to the PVOL 70P from the client server 201 (such as an application program) (S1510).

The I/O program 411 suspends a VOL pair including the PVOL 70P specified by the snapshot acquisition request (S1512). Namely, the pair status 904 of the VOL pair is updated to “SUSPEND.” As a result, the SVOL 70S can be settled to the same contents as the PVOL 70P at the suspension. At the suspension, there may be data (differential data) that is written to the PVOL 70P and is not copied to SVOL 70S. In such a case, the I/O program 411 copies the difference data to the SVOL 70S. As a result, the SVOL 70S can be assumed to be a VOL synchronized with the PVOL 70P at the suspension (S1514). The I/O program 411 receives a write request specifying the PVOL 70P even after the suspension. Therefore, the PVOL 70P is updated and the difference management occurs.

When the SVOL 70S is settled to the same contents as the PVOL 70P at the suspension, the I/O program 411 uses a journal to transfer the snapshot acquisition request to the server system 50 (S1516). For example, the journal contains the snapshot acquisition request in the form of a marker as a type of data in the journal. Journals not transferred to the server system 50 are transferred from the on-premise storage 200 to the server system 50 in the chronological order of journals (ascending order of journal numbers). The destination of the transferred journals is the active physical computer 110A (VOL 260A).

The data transfer program 113A transfers data to the public storage 120 based on the journal received from the on-premise storage 200. The transfer method is similar to that of S1216, for example.

Suppose the data transfer program 113A recognizes the completion of data transfer to the public storage 120 before the suspension. Namely, suppose the data transfer program 113A recognizes that the public storage 120 stores the same data as all data in the PVOL 70P verified when the on-premise storage 200 receives the snapshot acquisition request. In such a case, the data transfer program 113A issues a snapshot acquisition request to the public storage 120 (S1518).

For example, either of the following may be helpful to recognize “the completion of data transfer to the public storage 120 before the suspension.”
The management system 205 monitors situations of data transfer from the server system 50 to the public storage 120. The management system 205 recognizes “the completion of data transfer to the public storage 120 before the suspension” when data next transferred from the server system 50 to the public storage 120 is the marker (snapshot acquisition request). This is because data last transferred to the public storage 120 corresponds to the data last updated to the PVOL 70P before the PVOL 70P is suspended.
The data transfer program 113A recognizes “the completion of data transfer to the public storage 120 before the suspension” when data next transferred to the public storage 120 is the marker (snapshot acquisition request). This is because data last transferred to the public storage 120 corresponds to the data last updated to the PVOL 70P before the PVOL 70P is suspended.

The snapshot acquisition request transmitted to the public storage 120 at S1518 may be comparable to the marker contained in the journal as one type of data.

When backing up data stored in the on-premise storage 200, the public storage 120 can acquire a consistent snapshot by allowing the on-premise storage 200 and the server system 50 to cooperate in terms of the timing to acquire the snapshot.

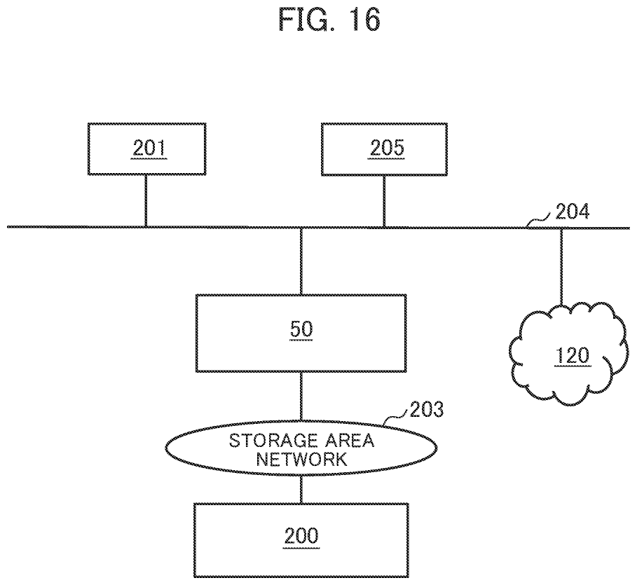

The present embodiment has been described. The configuration of the entire system is not limited to the one illustrated in FIG. 1. Another configuration such as the one illustrated in FIG. 16 may be adopted. Namely, the server system 50 and the on-premise storage 200 may be connected via a storage area network 203 instead of the network 204.

The above description can be summarized as follows, for example.

A comparative example of the method of backup in the hybrid cloud may provide a method of transferring data from business VOL in on-premise storage 200 to the public storage 120. However, as described above, this method cannot restore data lost from the business VOL. The I/O performance of the business VOL may degrade.

As a solution, the processor 211 of the on-premise storage 200 assumes the business VOL to be the PVOL 70P and generates the SVOL 70S that forms a VOL pair along with PVOL 70P. The processor 211 associates the generated SVOL 70S with the server system 50 (VOL 260). When accepting a write request specifying the PVOL 70P, the processor 211 writes data attached to the write request to the PVOL 70P and copies (backs up) the data to the SVOL 70S. The processor 211 transmits the data backed up in the SVOL 70S to the server system 50 to write the data to the public storage 120. As a result, a VOL consistent with PVOL 70P exists as the SVOL 70S. The I/O performance of PVOL 70P is unaffected because the backup to the public storage 120 is performed in terms of the SVOL 70S. It is possible to back up data consistent with the data in the business VOL of the on-premise storage 200 in the hybrid cloud without degrading the I/O performance of the business VOL.

Suppose the comparative example uses a single physical computer as the server system. If the single physical computer malfunctions, there is a need for restarting such as replacing the physical computer with another physical computer. It takes a long time to restart the physical computer after it malfunctions. In other words, a period to suspend the backup process increases.

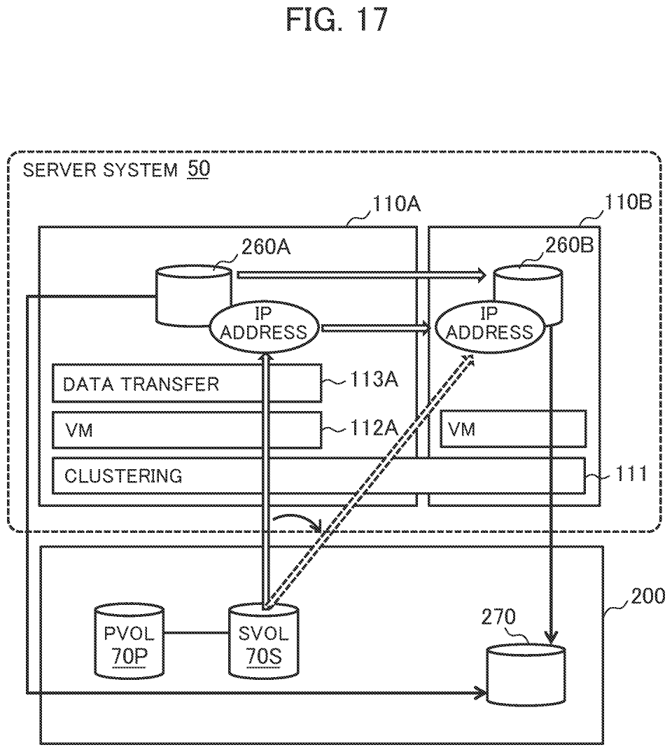

To solve this, as illustrated in FIG. 17, the server system 50 is provided as a cluster system comprised of the physical computers 110A and 110B exemplifying a plurality of physical computers 110. The processor 211 associates the SVOL 70S with the IP address (exemplifying a target address) of the VOL 260A (exemplifying a first logical volume) provided by the physical computer 110A. The on-premise storage 200 includes the shared area 270. The shared area 270 stores the shared information containing the IP address information 452 representing the IP address. Malfunction of the physical computer 110A, if occurred, causes a failure recovery including the fail-over from the physical computer 110A to the physical computer 110B. During this error recovery, the IP address specified from the IP address information 452 is inherited from the physical computer 110A (VOL 260A) to the physical computer 110B (VOL 260B exemplifying a second logical volume). The processor 211 of the on-premise storage 200 performs the transfer to the server system 50 by using the IP address represented by the IP address 503 corresponding to the SVOL 70S, namely, the same IP address as the IP address represented by the IP address information 452. Therefore, after the error recovery, data can be transferred to the physical computer 110B (VOL 260B) instead of the physical computer 110A (VOL 260A). In this way, the backup process can continue. The IP address may be inherited from the VOL 260A to the VOL 260B based on the VM migration (for example, as part of the fail-over including the VM migration) from the physical computer 110A to the physical computer 110B. This makes it possible to inherit the IP address through the use of VM migration. It is expected to eliminate or reduce additional processes to inherit the IP address.

The JVOL 70J is provided for one or more VOL pairs. According to the above-described embodiment, data contained in the journal stored in the JVOL 70J is written to the SVOL 70S. Instead, the data may be written to the PVOL 70P. In this case, each time data is backed up to the SVOL 70S (or each time data is written to the PVOL 70P), the processor 211 of the on-premise storage 200 generates a journal containing the data and being associated with the management information about the data and stores the generated journal in the JVOL 70J. The processor 211 transmits a journal containing data not transmitted to the server system 50, to the server system 50. The server system 50 transfers data in each of one or more journals unreflected to the public storage 120, to the public storage 120 in ascending order of the journal numbers. The “journal unreflected to the public storage 120” contains data not transmitted to the public storage 120, namely, data not written to public storage 120. It is difficult to complete a write request after data is written to the PVOL 70P in the on-premise storage 200 in response to the write request and the data is backed up to the public storage 120 via the server system 50. To solve this, the journal can be used to back up data to the public storage 120 asynchronously with the data writing to the PVOL 70P.

The management system 205 may monitor data transfer from the server system 50 to the public storage 120 and thereby manage the finally completed journal number 434 (the information representing the journal number of the journal containing data last transferred from the server system 50 to the public storage 120). The server system 50 may not include the journal management function because a vendor of the on-premise storage 200 cannot add or change the function of the server system 50 or due to other reasons. Even in this case, the vendor of the on-premise storage 200 can be expected to configure the management system 205 and thereby maintain the data consistency between the on-premise storage 200 and the public storage 120. For example, the management system 205 can request the server system 50 to transfer, to the public storage 120, a journal assigned a journal number larger than the journal number represented by the finally completed journal number 434, namely, one example of a journal newer than the one last reflected in the public storage 120. Alternatively, the management system 205 can request the on-premise storage 200 to transmit, to the server system 50, a journal assigned a journal number larger than the journal number represented by the finally completed journal number 434.

Instead of a journal, data in the journal may be transmitted from the on-premise storage 200 to the server system 50. The management system 205 may monitor data transfer from the on-premise storage 200 to the server system 50 and thereby manage the chronological order of journals transferred to the server system 50. The server system 50 may not include the journal management function because a vendor (or provider) of the on-premise storage 200 cannot add or change the function of the server system 50 or due to other reasons. Even in this case, the vendor (or provider) of the on-premise storage 200 can configure the management system 205 and can be expected to support the accumulation of journals in the server system 50 without losing journals. For example, the management system 205 may detect the discontinuity of journal numbers in the server system 50. In such a case, the management system 205 can request the on-premise storage 200 to transmit a missing journal.

The transmission source (such as an application) of an I/O request may transmit a request to acquire a snapshot of the PVOL 70P. In such a case, the processor 211 of the on-premise storage 200 acquires the snapshot of the PVOL 70P in response to the snapshot acquisition request.

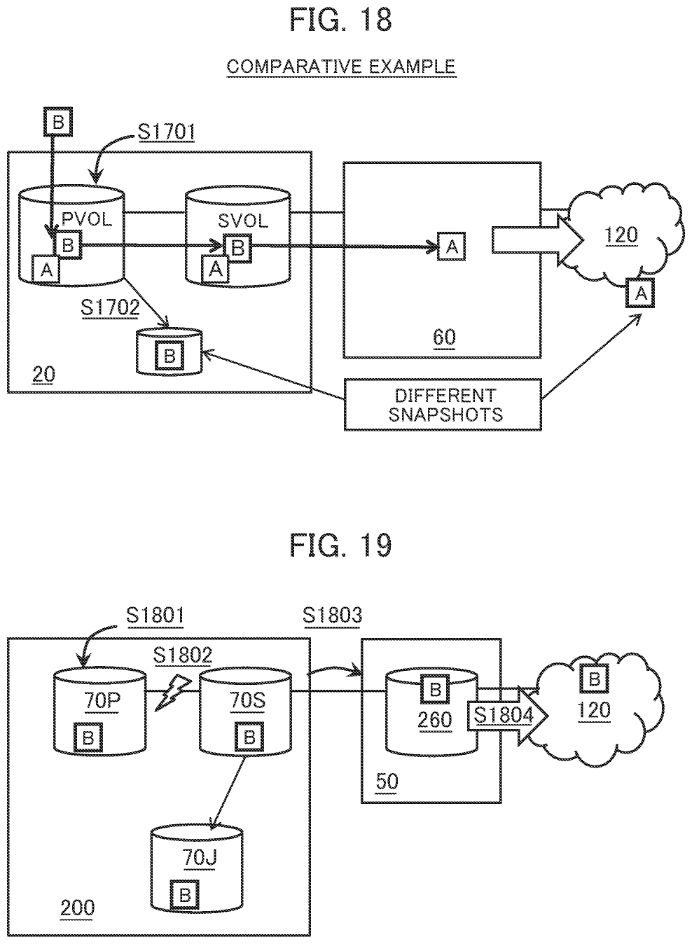

According to a comparative example illustrated in FIG. 18, the on-premise storage 20 updates data A in the PVOL to data B. Then, data B is reflected in the SVOL and is transmitted to the server system 60. However, the timing to reflect data B in the public storage 120 depends on the server system 60. When accepting the snapshot acquisition request (S1701), the on-premise storage 20 acquires the snapshot including data B (S1702). In this case, if data B does not reach the public storage 120, there is no consistency between the snapshot in the on-premise storage 20 and the data in the public storage 120.

As illustrated in FIG. 19, when the processor 211 of the on-premise storage 200 receives the snapshot acquisition request, the snapshot acquisition request is linked to the public storage 120 via the server system 50. Data B is stored in the PVOL 70P according to the example illustrated in FIG. 19. Therefore, data B is stored in the SVOL 70S and the journal containing data B is stored in the JVOL 70J. The processor 211 receives a snapshot acquisition request (an example of the first snapshot acquisition request) (S1801). Then, the processor 211 suspends the VOL pair of the PVOL 70P and the SVOL 70S (S1802). The processor 211 subsequently compares the time at the suspension with the update time 702 in the management information of the journal not reflected in the SVOL 70S. Alternatively, using other methods, the processor 211 determines the presence or absence of differential data that exists in the PVOL 70P at the suspension but does not exist in the SVOL 70S. The example here assumes that there is no such difference data. The processor 211 transmits a journal containing data B to the server system 50 (S1803). In addition to the journal, the processor 211 transmits a snapshot acquisition request (an example of the second snapshot acquisition request) to the server system 50 (S1803). The server system 50 transmits data B in the journal to the public storage 120 and transmits the snapshot acquisition request to the public storage 120 (S1804). The processor 211 of the on-premise storage 200 receives the completion response to the snapshot acquisition request from the server system 50 that received the snapshot acquisition request and transmitted the unreflected data B to the public storage 120. Consequently, the snapshot acquisition request is linked to maintain the consistency between the snapshot in on-premise storage 200 and the snapshot in public storage 120.

As above, the snapshot consistency is effectively maintained by generating a journal, transferring a journal from the on-premise storage 200 to the server system 50, and transferring data in a journal from the server system 50 to the public storage 120. In particular, for example, the snapshot acquisition request transmitted from the on-premise storage 200 to the server system 50 may be comparable to a marker as one type of data in the journal. The snapshot acquisition request transmitted from the server system 50 to the public storage 120 may be comparable to one type of transfer of data in the journal. Consequently, the transfer of a journal or the transmission of data in the journal can be assumed to be the transmission (cooperation) of the snapshot acquisition request.

While there has been described one embodiment of the present invention, it is to be distinctly understood that the present invention is not limited to this embodiment and may be variously modified without departing from the scope of the invention.

What is claimed is:

1. A method of protecting data in a hybrid cloud that includes cloud storage as a cloud-based storage system and local storage as a storage system provided by a provider different from a provider providing the cloud storage, the method comprising:
allowing the local storage to generate a backup area as a storage area to which data written in an online volume is backed up;
allowing the local storage to associate the generated backup area with a server system that provides access from the local storage to the cloud storage;
allowing the local storage to receive a write request specifying the online volume, write the data contained in the write request to the online volume, and back up the data in the backup area; and
allowing the local storage to write data backed up in the backup area to the cloud storage by transmitting the data to the server system from the backup area.

2. The method according to claim 1,
wherein the local storage associates a target address as an address to a first logical volume provided by a first physical computer with the backup area,
wherein the server system is a cluster system based on a plurality of physical computers including the first physical computer, and when receiving data for the first logical volume, the server system transmits the data to the cloud storage,
wherein the local storage stores shared information that contains the target address and is shared by the local storage and the server system,
wherein the target address specified from the shared information is inherited from the first physical computer to a second logical volume provided by the second physical computer during an error recovery that includes fail-over from the first physical computer to a second physical computer and is performed when the first physical computer malfunctions, and
wherein the local storage designates the target address during transmission of data backed up in the backup area to the server system.

3. The method according to claim 2,
wherein the fail-over includes migration of a virtual machine from the first physical computer to the second physical computer, and
wherein the target address is inherited from the first physical computer to the second physical computer due to the migration.

4. The method according to claim 2,
wherein the local storage generates a journal including data written to the online volume and being associated with management information of the data and stores the journal in the backup area,
wherein, for each journal, the management information contains information indicating a storage destination address of data in the journal and information containing a journal number signifying an order of the data,
wherein the local storage transmits, to the server system, a journal containing data untransmitted to the server system, and
wherein the server system transfers data in each of one or more journals unreflected in the cloud storage to the cloud storage in chronological order of journals.

5. The method according to claim 4,
wherein a management system connected to the server system monitors data transfer from the server system to the cloud storage, thereby managing a journal number of a journal containing data last transferred from the server system to the cloud storage.

6. The method according to claim 2,
wherein the local storage generates a journal containing data written to the online volume and being associated with management information about the data and stores the journal in the backup area,
wherein for each journal, the management information contains information indicating a storage destination address of data in the journal and information containing a journal number signifying an order of the data, and
wherein the local storage transmits, to the server system, data in each of one or more journals containing data untransmitted to the server system, in chronological order of journals.

7. The method according to claim 6,
wherein a management system connected to the server system manages a chronological order of journals transferred to the server system by monitoring data transfer from the local storage to the server system.

8. The method according to claim 1,
wherein the backup area includes the online volume as a primary volume and a secondary volume that forms a volume pair with the online volume,
wherein when receiving a first snapshot acquisition request for the online volume, the local storage places the volume pair in a suspension state,
wherein the suspension state suspends copying of data to the secondary volume even if the data is written to the online volume,
wherein, out of data in the same secondary volume as the online volume at the time when the volume pair enters the suspension state, the local storage transmits data unreflected in the server system and a second snapshot acquisition request to the server system, and
wherein the local storage receives a completion response to the second snapshot acquisition request from the server system that receives the second snapshot acquisition request and transmits all of the unreflected data to the cloud storage.

9. The method according to claim 8,
wherein the local storage generates a journal that contains data written to the online volume and is associated with management information about the data,
wherein, for each journal, the management information contains information representing a storage destination address of data in the journal and information representing a journal number signifying an order of the data,
wherein the local storage transmits, to the server system, a journal containing data untransmitted to the server system, and
wherein the server system transfers, to the cloud storage, data in each of one or more journals unreflected in the cloud storage in ascending order of journal numbers.

10. The method according to claim 9,
wherein the second snapshot acquisition request is a marker contained as one type of data in a journal transferred to the server system.

11. The method according to claim 9,
wherein a management system connected to the server system monitors a data transfer from the server system to the cloud storage and thereby manages a journal number of a journal containing data last transferred from the server system to the cloud storage.

12. The method according to claim 9,
wherein a management system connected to the server system monitors journal transfer from the local storage to the server system and thereby manages a chronological order of journals transferred to the server system.

13. The method according to claim 8,
wherein the local storage associates a target address, that is an address to the first logical volume provided by the first physical computer, with the secondary volume,
wherein the server system is a cluster system based on a plurality of physical computers including the first physical computer and, when receiving data for the first logical volume, transmits the data to the cloud storage,
wherein the local storage stores shared information, that is information that contains the target address and is shared by the local storage and the plurality of physical computers of the server system,
wherein the target address identified from the shared information is inherited from the first physical computer to a logical volume provided by the second physical computer in the fail-over from the first physical computer to the second physical computer, being performed when the first physical computer malfunctions, and
wherein the local storage specifies the target address when data copied to the secondary volume is transmitted to the server system.

14. A storage system that is provided in a hybrid cloud including cloud storage as a cloud-based storage system and is provided by a person different from a person who provides the cloud storage, the storage system comprising:
a communication interface apparatus connected to a server system that provides access to the cloud storage;
a storage apparatus to store data attached to a write request; and
a processor connected to the communication interface apparatus and the storage apparatus,
wherein the processor generates a backup area as a storage area to which data written to an online volume is backed up,
wherein the processor associates the generated backup area with the server system,
wherein, when receiving a write request assigned with the online volume, the processor writes the data attached to the write request to the online volume and backs up the data to the backup area, and
wherein the processor transmits data backed up in the backup area from the backup area to the server system to write the data to the cloud storage.
